(19) United States
(12) Patent Application Publication
(10) Pub. No.: US 2004/0235325 A1
(43) Pub. Date: Nov. 25, 2004

(54) Card connector with ejection mechanism

(76) Inventor: Hideki Iijima, Yamato-shi Kanagawa (JP)

Correspondence Address: Stacey E Caldwell, Molex Incorporated, 2222 Wellington Court, Lisle, IL, 60532, US

(21) Appl. No.: 10/482,019

(22) PCT Filed: Jun. 14, 2002
(86) PCT No.: PCT/US02/19032

(30) Foreign Application Priority Data
Jun. 27, 2001 (JP) 2001-194525

(51) Int. Cl. H01R 13/62

(52) U.S. Cl. 439/159

(57) ABSTRACT

A memory card connector (10) includes a generally flat housing (12) for receiving a planar memory (18) card in an insertion and ejection direction. An ejection rod is reciprocally mounted on the housing for linear movement generally parallel to the insertion and ejection direction (20). An ejection lever (58) is pivotally mounted on the housing and is operatively associated with the ejection rod (48) for pivoting the lever in response to linear movement of the rod. The ejection lever has a generally flat plate (60) which is generally coplanar with the memory card, with the plate having a side edge (66) for engaging the card. The side edge of the lever has a generally convex configuration defining a center engaging portion for engaging the card during a first portion of an ejection stroke of the card and an end engaging portion (70) for engaging the card during a subsequent portion of the ejection stroke of the card.

### FIELD OF THE INVENTION

This invention generally relates to the art of electrical connectors and, particularly, to a card connector which permits insertion and removal of a card-type memory medium (or memory card).

### BACKGROUND OF THE INVENTION

Card connectors which permit insertion and removal of a memory card have been known, as disclosed in Japanese Examined Utility Model Publication (Kokoku) No. Heisei 7-31322, Japanese Patent No. 2761490 which corresponds to U.S. Pat. No. 5,383,789 to Watanabe, Japanese Patent No. 2781854, Japanese Unexamined Patent Publication No. Heisei 8-129620 which corresponds to European Patent First Publication No. 0712178, Japanese Unexamined Patent Publication No. Heisei 9-82411 which corresponds to International Publication WO 97/10691, and Japanese Unexamined Patent Publication No. Heisei 10-189139, for example. These types of card connectors typically include an ejection mechanism which has an ejection rod movable in a direction generally parallel to the insertion and ejection direction of the memory card. An ejection lever typically is engaged by a tip end of the ejection rod whereby a memory card inserted into the card connector can be ejected by pushing on the ejection rod and pivoting the ejection lever.

With many ejection mechanisms as described above, some form of engaging member projects from the ejection lever for engaging a front end or edge of the card. The engaging member typically is formed at an end of the ejection lever so that it does not interfere with the terminals of the connector. Unfortunately, such engaging members add a thickness dimension to the overall card connector, when down-sizing and reductions of the thickness of the memory card and the connector, itself, is highly desirable and even required in some applications. The present invention is directed to solving these problems by providing an improved ejection mechanism which does not significantly increase the thickness dimensions of the card connector.

### SUMMARY OF THE INVENTION

An object, therefore, of the invention is to provide a memory card connector with a new and improved ejection mechanism.

In the exemplary embodiment of the invention, the card connector includes a generally flat housing for receiving a planar memory card in an insertion and ejection direction. An ejection rod is reciprocally mounted on the housing for linear movement generally parallel to the insertion and ejection direction. An ejection lever is pivotally mounted on the housing and is operatively associated with the ejection rod for pivoting the lever in response to linear movement of the rod. The ejection lever is in the form of a generally flat plate generally coplanar with the memory card and having a side edge for engaging a front end of the memory card. The side edge of the ejection lever has a generally convex configuration defining a center portion for engaging the front end of the memory card during a first portion of an ejection stroke of the card and an end portion for engaging the front end of the memory card during a subsequent portion of the ejection stroke of the card.

As disclosed herein, the generally flat ejection lever has a thickness no greater than the thickness of the memory card. Preferably, the lever has a thickness less than the thickness of the memory card.

According to one aspect of the invention, the ejection lever is elongated to define a first, proximal end and a second, distal end. The lever is pivoted to the housing near the proximal end thereof, and the end engaging portion of the lever is near the distal end thereof.

According to another aspect of the invention, the housing defines a card-receiving cavity enclosed by a cover which has a plurality of narrow ribs projecting into the cavity for engaging a flat surface of the memory card during insertion and ejection of the card into and out of the cavity. At least two of the narrow ribs are spaced transversely of the insertion and ejection direction of the memory card. At least two ribs are elongated in the insertion and ejection direction of the memory card. Preferably, the cover is fabricated of sheet metal material.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a top plan view of a card connector according to the invention;

FIG. 2 is a side elevational view of the card;

FIG. 3 is an enlarged vertical section taken generally alone line 3-3 of FIG. 1;

FIG. 4 is an illustration wherein the cover of the card connector has been removed, and showing a memory card inserted into the housing; and

FIG. 5 is a view similar to that of FIG. 4, with the ejection mechanism in condition of ejecting the memory card.

### DETAILED DESCRIPTION OF THE PREFERRED EMBODIMENT

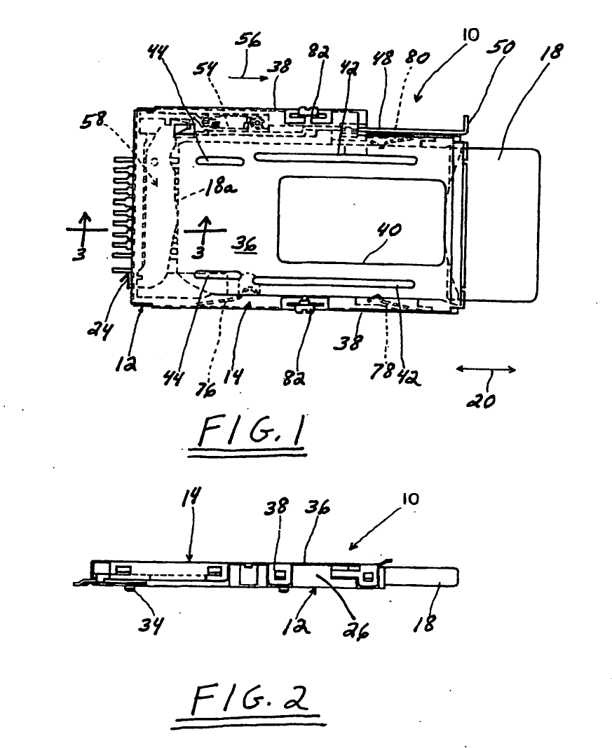

Referring to the drawings in greater detail, and first to FIGS. 1-3, the invention is embodied in a card connector, generally designated 10, which includes an insulating or dielectric housing, generally designated 12, and a cover, generally designated 14. The housing may be fabricated of molded plastic material or the like. The cover may be stamped and formed of sheet metal material. The housing and cover have a generally flat configuration and define a card-receiving cavity 16 (FIG. 3) therebetween for receiving a planar memory card 18 in an insertion and ejection direction indicated by double-headed arrow 20 (FIG. 1).

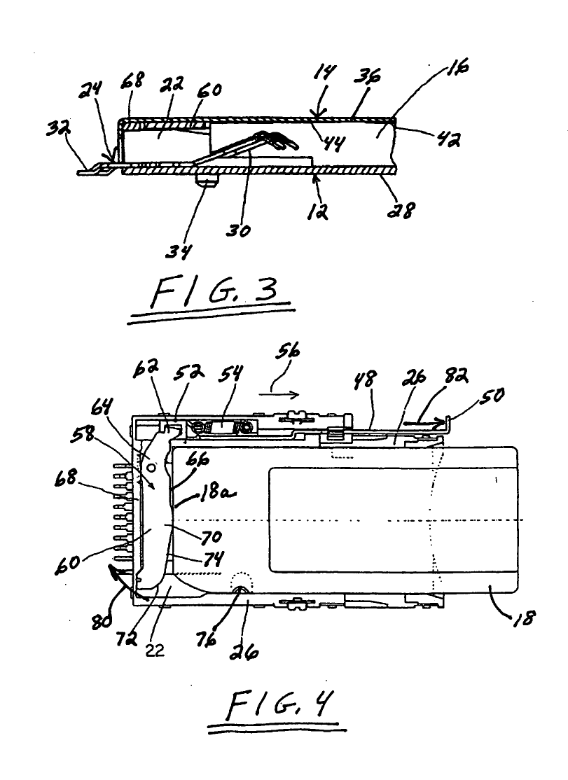

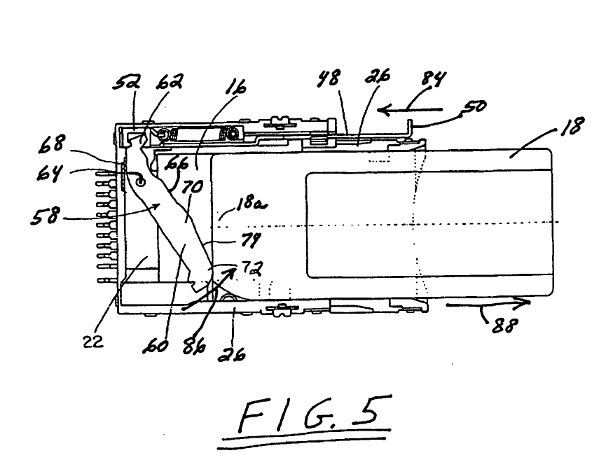

Dielectric housing 12 includes a body portion 22 within which a plurality of terminals, generally designated 24, are mounted in a side-by-side relationship transversely of the insertion and ejection direction 20. The housing has a pair of side walls 26 (see FIG. 4) projecting from body portion 22. The side walls, along with a bottom wall 28 (FIG. 3) of the housing, combine with cover 14 to define cavity 16.

Terminals 24 are mounted in body portion 22 of housing 12 and include contact portions 30 projecting into cavity 16 as is clearly seen in FIG. 3. The terminals have tail portions 32 projecting out of the housing for connection, as by soldering, to appropriate circuit traces on a printed circuit board (not shown). The housing has a plurality of mounting feet 34 for insertion into appropriate holes in the printed circuit board. Contact portions 30 of terminals 24 are positioned within cavity 16 for engaging appropriate contacts (not shown) on the bottom surface of memory card 18 as is known in the art.

As stated above, cover 14 of connector 10 is stamped and formed of sheet metal material. The metal material may be stainless steel or the like. The cover includes a top wall 36 covering the top of housing 12, along with side walls 38 which extend over and are latched to side walls 26 of the housing. Top wall 36 combines with bottom wall 28 and side walls 26 of the housing to define cavity 16.

As best seen in FIG. 1, top wall 36 of cover 14 includes a window 40, a pair of ribs 42 outside opposite sides of the window and extending in the insertion and ejection direction 20 of memory card 18, and a pair of ribs 44 in front of ribs 42 and also extending in the insertion and ejection direction 20 of memory card 18. Ribs 44 are narrow in a direction transversely of the insertion and ejection direction of the memory card and are formed out of top wall 36 of cover 14 to an extent that the ribs project slightly into card-receiving cavity 16.

When memory card 18 is inserted and ejected into and out of cavity 16, the narrow and thin ribs 42 and 44 are the only portions of cover 14 which engage the top surface of the memory card. Therefore, very little if any resistance is created between the card and the cover. In addition, the ribs provide a smooth sliding engagement between the cover and the card.

Card connector 10 is provided with an ejection mechanism which includes an ejection rod 48 installed along one side wall 26 of housing 12. As best seen in FIG. 4, ejection rod 48 is bent at its outer end to define a pushing portion 50. A connecting portion 52 is secured to an inner end of the rod. The ejection rod is movable linearly back and forth along side wall 26 of the housing generally parallel to the insertion and ejection direction 20 of primary card 18. A coil spring 54 is connected between connecting portion 52 of the rod and the housing to constantly bias the ejection rod in an ejection direction as indicated by arrow 56 (FIG. 1).

The ejection mechanism of card connector 10 further includes an ejection lever, generally designated 58, which has a generally flat plate or body portion 60. The lever has a proximal end connected to connecting portion 52 at the inner end of ejection rod 48, as best seen in FIG. 4. The lever is pivoted to the housing at a pivot point 64 near the proximal end of the lever. The flat plate or body portion 60 of the lever has a side edge 66 which is generally convex in configuration for engaging a front end or edge 18a of memory card 18. A wall portion 68 of housing 12 is disposed on a back side of lever 58 opposite side edge 66. The convex side edge 66 of the lever includes a center engaging portion 70, an end engaging portion 72 at a distal end of the lever, and an angled or tapered edge portion 74 between the center engaging portion and the end engaging portion.

As best in seen in FIG. 3, flat plate or body portion 60 of the ejection lever is very thin. It has a thickness no greater than the thickness of memory card 18 as can be seen in FIG. 2. Preferably, the flat plate of the ejection lever has a thickness considerably less than the thickness of the memory card, as can be seen in comparing FIGS. 2 and 3. Therefore, the ejection mechanism, particularly the ejection lever, does not in any way interfere with down-sizing or reducing the overall thickness of the card connector.

Finally, card connector 10 includes card lock 76 (FIG. 1), a detection switch 78, a biasing spring 80 and reinforcements 82 among other components which are conventional in card connectors, outside the scope of the inventive concepts herein and will not be described in detail.

In operation, FIGS. 4 and 5 are somewhat illustrative only, in that cover 14 has been completely removed in order to show the interior positioning of memory card 18 and the ejection mechanism, particularly ejection lever 58. FIG. 4 shows memory card 18 fully inserted into the connector and locked at 76. Ejection lever 58 has been pivoted in the direction of arrow 80, while ejection rod 48 has been pushed linearly outwardly in the direction of arrow 82.

FIG. 5 shows ejection rod 48 having been pushed inwardly in the direction of arrow 84 by pushing on outer end or pushing portion 50 of the rod. Since proximal end 62 of ejection lever 58 is connected to connecting portion 52 at the inner end of the rod, the ejection lever will be pivoted in the direction of arrow 86, whereupon memory card 18 will be ejected in the direction of arrow 88. During ejection, center engaging portion 70 of flat plate 60 of ejection lever 58 engages front end 18a of the memory card during a first portion or half of the ejection stroke of the card in the direction of arrow 88. During the second portion or half of the ejection stroke of the memory card, front end 18a of the card first engages angled edge portion 74 and then engages end engaging portion 72 of convex side edge 66 of the ejection lever. As is known, it becomes easier to eject a memory card as the card progressively moves out of the connector because the many restraining forces are reduced as the card is freed out of the connector cavity. By providing a convex edge 66 of flat plate 60 of the ejection lever, the initial moment arm of the lever is shorter during the heavier ejection forces and progressively increases toward the end of the flat thin plate 60 of the lever. This helps to prevent the flat thin plate from buckling during the initial ejection stroke of the memory card when the forces are the greatest.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector, comprising:
a generally flat housing for receiving a planar memory card in an insertion and ejection direction;
an ejection rod reciprocally mounted on the housing for linear movement generally parallel to said insertion and ejection direction of the memory card; and
an ejection lever pivotally mounted on the housing and operatively associated with the ejection rod for pivoting the lever in response to linear movement of the rod,
the ejection lever being in the form of a generally flat plate generally coplanar with the memory card and having a side edge for engaging a front end of the memory card, and
the side edge of the ejection lever having a generally convex configuration defining a center engaging portion for engaging the front end of the memory card during a first portion of an ejection stroke of the card and an end engaging portion for engaging the front end of the memory card during a subsequent portion of the ejection stroke of the card.

2. The memory card connector of claim 1 wherein the generally flat ejection lever has a thickness no greater than the thickness of the memory card.

3. The memory card connector of claim 1 wherein the generally flat ejection lever has a thickness less than the thickness of the memory card.

4. The memory card connector of claim 1 wherein said ejection lever is elongated to define a first, proximal end and a second, distal end, the lever being pivoted to the housing near the proximal end thereof, and said end portion of the lever being near the distal end thereof.

5. The memory card connector of claim 1 wherein said housing defines a card-receiving cavity enclosed by a cover which has a plurality of narrow ribs projecting into the cavity for engaging a flat surface of the memory card during insertion and ejection of the card into and out of the cavity.

6. The memory card connector of claim 5 wherein said plurality of narrow ribs include at least two ribs spaced transversely of the insertion and ejection direction of the memory card.

7. The memory card connector of claim 6 wherein said at least two ribs are elongated in said insertion and ejection direction of the memory card.

8. The memory card connector of claim 7 wherein said cover is fabricated of sheet metal material.

9. A memory card connector, comprising:
a generally flat housing defining a memory card-receiving cavity; and
a generally flat cover enclosing the cavity and including a plurality of narrow ribs projecting into the cavity for engaging a flat surface of a memory card during insertion and removal of the card into and out of the cavity.

10. The memory card connector of claim 9 wherein said plurality of narrow ribs include at least two ribs spaced transversely of an insertion and ejection direction of the memory card.

11. The memory card connector of claim 10 wherein said at least two ribs are elongated in said insertion and ejection direction of the memory card.

12. The memory card connector of claim 11 wherein said cover is fabricated of sheet metal material.
